(19) United States
(12) Patent Application Publication
(10) Pub. No.: US 2012/0170618 A1
(43) Pub. Date: Jul. 5, 2012

(54) Ultra wideband time-delayed correlator

(75) Inventors: Mark A. Chivers, McKinney, TX (US); Sujit Ravindran, McKinney, TX (US)

(73) Assignee: ABG TAG & TRAQ, LLC

(21) Appl. No.: 13/199,416

(22) Filed: Aug. 30, 2011

Related U.S. Application Data
(60) Provisional application No. 61/457,126, filed on Jan. 4, 2011.

(51) Int. Cl. H04B 1/707

(52) U.S. Cl. 375/150; 375/E01.002

(57) ABSTRACT

The present invention is for a method and apparatus to improve an Ultra Wideband (UWB) digital receiver's performance sensitivity. A transmitted signal stream has each data bit having multiple identical modulated pulses separated by a constant time interval. The received signal stream is duplicated to create a second signal stream of identical modulated pulses to the original signal stream. The duplicated signal stream is delayed by the constant time interval between identical modulated pulses and the two signal streams correlated to form one signal stream which is detected to improve the sensitivity of the receiver.

This application claims the benefit of U.S. Provisional Application No. 61/457,126, filed Jan. 4, 2011 for Ultra Wideband Time-Delayed Correlator.

### BACKGROUND OF THE INVENTION

Ultra-wideband (UWB) communication systems employ very short pulses of electromagnetic radiation or impulses with short rise and fall times which results in a spectrum with a very wide bandwidth. UWB communications have a number of advantages over conventional systems. The very large bandwidth for instance facilitates very high data rate communications and since pulses of radiation are employed the average transmit power may be kept low even though the power in each pulse is relatively large. Since the power in each pulse is spread over a large bandwidth the power per unit frequency may be very low, allowing UWB systems to coexist with other spectrum users and providing a low probability of intercept. UWB techniques are attractive for short range wireless devices, such as radio frequency identification (RFID) systems, because they allow devices to exchange information at relatively high data rates. For instance, an Ultra Wideband Radio Frequency Identification Technique system may be seen in the Reunamaki U.S. Pat. No. 7,733,229 in which UWB techniques are applied to RFID in which a reader generates a UWB IR interrogation signal and receives a UWB IR reply signal from an RFID tag in response to the interrogation signal.

Federal Communications Commission (FCC) defines a UWB pulse as one whose 10 dB bandwidth either is at least 500 MHz or whose fractional bandwidth is greater than 0.20. The 500 MHz minimum bandwidth limit sets a threshold at 2.5 GHz. Below this 2.5 GHz threshold signals are considered UWB if their fractional bandwidth exceeds 0.20, while above the threshold signals are UWB if their bandwidth exceeds 500 MHz. Fractional bandwidth is defined as the ratio of the 10 dB bandwidth to the center frequency. For example, a 500 MHz 10 dB bandwidth UWB signal centered at 6 GHz has a fractional bandwidth of 0.083 (500/6000). For UWB whose center frequency is greater than 2.5 GHz, the 500 MHz 10 dB analog bandwidth needs to be processed.

In our past U.S. patent application Ser. No. 12/387,425; filed May 1, 2009, for Pulse-Level Interleaving for UWB Systems, a UWB transmitter transmits a multi-pulse per bit signal to a UWB receiver for multi-bit processing. A bit stream is transmitted using a plurality of UWB pulses for each bit frame. The pulse level interleaving of the pulses is accomplished prior to transmission of the signals by a plurality of UWB transmitters operating at the same time. The receiver de-interleaves the pulses and then aggregates the energy from the multiple pulses within each frame.

The purpose of the present invention is to improve an Ultra Wideband (UWB) digital receiver's performance sensitivity. A key measurement to evaluate a UWB digital receiver's performance sensitivity is Signal to Noise and distortion Ratio (SINAD). In a communications link, the transmitted signal is degraded by undesired impairments and extraneous signals. The received signal is a superposition of linear additive noise components and nonlinear distortions. Nonlinear distortion comes from a variety of causes, including but not limited to multipath, which not only can distort but also attenuate signals through the different radio frequency phenomena: scattering, reflection, and diffraction. Signal degradation of all these channel impairments result in limiting the potential range of the communications system.

### SUMMARY OF THE INVENTION

The present invention is for a method and apparatus to improve an Ultra Wideband (UWB) digital receiver's performance sensitivity. A transmitted signal stream having multiple identical pulses per modulated bit has each bit of multiple pulses separated by a constant time interval. The receiver receives the signal stream and duplicates the signal stream into a plurality of duplicate identical signal streams of identical modulated pulses. Each duplicate signal stream is delayed by the constant time interval between the identical modulated pulses to thereby align the first pulse of the duplicate signal stream with the second pulse of original signal stream. The signal streams are then correlated to form one signal stream which is detected to improve the sensitivity of a receiver.

A method of improving an ultra wideband digital receiver's sensitivity includes a receiver receiving a signal stream consisting of multiple modulated pulses representing each data bit with every pulse having a constant pulse repetition interval (PRI). The signal stream having multiple identical modulated pulses for each data bit are then duplicated to create a second identical signal stream of identical modulated pulses. The duplicated signal stream is then delayed by the time interval of the PRI constant time interval between the matching modulated pulses to thereby align each first modulated pulse of the duplicated signal stream with the second modulated pulse of the original received signal stream. The signal streams are then correlated by multiplication and down- sampling into a single signal stream of modulated pulses which signal stream is then detected by the receiver with improved sensitivity.

An ultra wideband digital receiver with improved sensitivity includes means for receiving an ultra wideband digital signal stream having multiple identical pulses for each data bit with each identical pulse having a constant time interval therebetween. Duplication means duplicate each signal stream of the multiple pulses of each data bit into a plurality of separate signal streams of multiple modulated pulses streams. The receiver has means for aligning the plurality of separate signal streams by delaying one or more duplicate signal streams by the time interval between identical multiple pulses of the received signal stream. The first pulse of a duplicate signal stream is aligned with the second pulse of the received signal stream and the second pulse of the duplicate stream is aligned with the third pulse of the received signal stream and so on. The receiver has means to correlate the aligned pulses of each of the separated signal streams to form one signal stream from the plurality of signal streams. The receiver then detects the correlated signal streams to improve the sensitivity of the ultra wideband receiver.

### BRIEF DESCRIPTION OF THE DRAWINGS

The accompanying drawings, which are included to provide a further understanding of the invention and are incorporated in and constitute a part of the specification, illustrate an embodiment of the invention and together with the description serve to explain the principles of the invention.

In the drawings:

FIG. 1 is a block diagram of an ultra wideband receiver, including the analog and digital boards, in accordance with the present invention; and

FIG. 2 is the digital board signal flow diagram.

### DETAILED DESCRIPTION OF AN EXEMPLARY EMBODIMENT

In order to improve the signal to noise ratio, the present invention exploits the coherence of the received signal to emphasize the signal and deemphasize the random noise. Correlation is a mathematical operation that indicates the degree to which two signal inputs are similar. The general idea is to multiply two signals at different points in time; then, integrate to determine the area under the curve over a finite period.

### Cross-Correlation Operation:

$$f [ n ] * g [ n ] = {{\sum }_{o}}^{x} f [ u ] * g [ n + u ] \\ n = 0 , 1 , 2 , … \qquad ( 1 )$$

In the above equation, both f[n] and g[n] are two independently random variables. In a Classic Matched Filter (CMF), the known clean signal is correlated with the received signal that has been corrupted by channel noise and distortions. The known clean signal is a predefined template very similar to the pulse that is transmitted. Unfortunately, since the predefined template is uncorrupted, this method fails to take into account the specific channel properties that result in distorting the received signal. Furthermore, in a mobile communications system, the channel is dynamic and, therefore, ever changing.

A more accurate method of correlation is to compare a received pulse that has been corrupted by a channel's distortions with another pulse that has been corrupted by the very same channel. This provides a higher correlation. In the present invention each received pulse serves as a correlation template for the subsequent pulse. This invention is intended to be used in conjunction with the multiple pulses per bit on-off keying (OOK) modulation technique. A plurality of pulses is transmitted to represent a data bit 1 and the absence of the plurality of pulses represents a data bit 0. Each pulse is transmitted at a constant interval, T_pri. At the receiver, the energy of the plurality of pulses is combined before detection takes place. Since additional pulses are already being transmitted through the same channel, we can utilize the existing modulation scheme to achieve a higher correlation. Delaying the received pulses by T_pri units in time causes the first pulse to align with the second pulse, the second pulse to align with the third pulse, etc.

The Time-Delayed Correlation Operation is shown by:

f[n]*f[n+T pri]=Σf[u]·f[n+T pri+u]n=0,1,2, . . . (2)

where T_pri=pulse repetition interval.

T_pri is equal to the sample rate in mega samples-per-second divided by pulse repetition interval in nanoseconds. For example, if pulses are transmitted every 100 ns and digitally sampled at 1280 msps, then T_pri=1280 msps×2000 ns=2560 clocks. This time-delayed correlation process requires that at least two pulses be transmitted to represent each bit. It will maximize the signal to noise ratio, when used in conjunction with the multiple pulses per bit scheme.

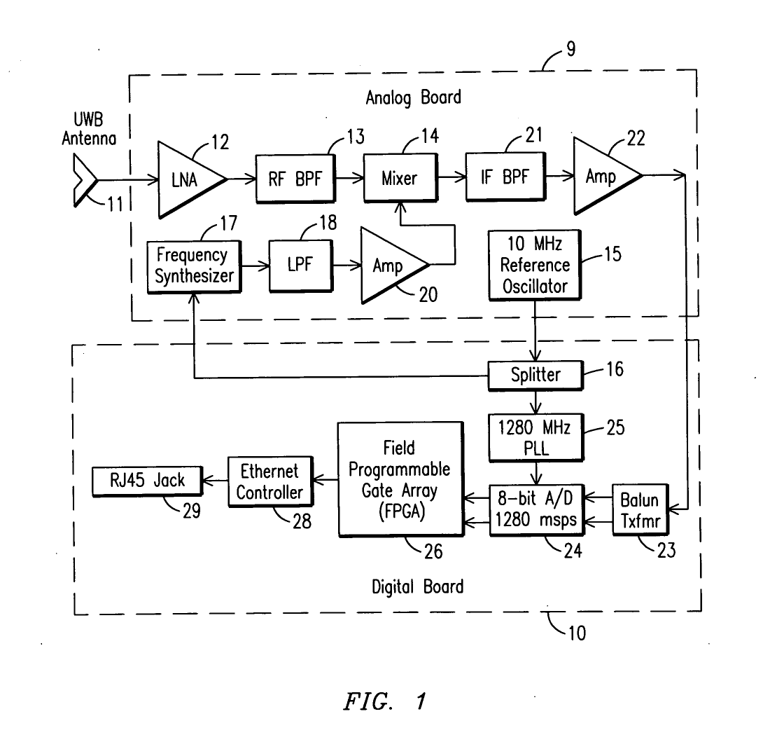

The present ultra-wideband receiver is a super heterodyne receiver having two boards: an analog board 9 and a digital board 10, along with a power conditioning board (not shown)as shown in FIG. 1. The UWB signal's conditioning, processing, decoding, and time-stamping are done by the analog and digital boards. In the first stage, the output from the receiver antenna 11 feeds directly into the analog board 9, where it is amplified, filtered, and then down converted to an intermediate frequency (IF) centered at 320 MHz. In the second stage the down converted (IF) signal is outputted to the digital board 10 where it is sampled at 1280 msps and fed to a field programmable gate array (FPGA) 24 for digital signal processing. In the FPGA, the sampled IF signal is digitally processed in two primary parts. The first part is where the time-stream delayed correlation is performed. In this part a delayed version of the 1280 msps input stream is created and the original 1280 msps input stream and the new delayed waveform input stream. A PRI of 2000 ns at 1280 msps translates to 2560 clocks (sample rate×PRI→1280 msps×2000 ns/1000). This delays the first waveform by 2560 clocks to create a second waveform so that the second pulse of the first waveform aligns with the first pulse of second waveform. The two waveforms are then multiplied. The output of the multiplier is down-sampled and summed over a finite duration. This is then fed into a low pass filter (LPF) to smooth the waveform. The LPF outputs the signal into the DSP where it is detected, measured, time-stamped, and decoded.

Referring to the drawings an especially to FIG. 1, the ultra-wideband receiver circuit shown is a super heterodyne receiver having two basic circuits, an analog circuit 9 and a digital circuit 10. The power supply is, not shown. The ultra wideband (UWB) signal Hz has a pulse repetition interval (PRI) of 2000 ns. The UWB signal's conditioning, processing, decoding, and time-stamping are done by the analog and digital circuits.

In the first stage, as seen in FIG. 1, the analog circuit 9 receives the output from the receiver antenna 11 which then amplifies the signal in a low noise RF amplifier 12 (LNA) and filters the signal through an 6.25 GHz RF bandpass filter 13 (RF BPF) and then down converts the signal to an intermediate frequency (IF) in the mixer 14. The mixer 14 is being fed a 6.57 GHz continuous wave (CW) signal generated by the synthesizer 17 which is filtered in the low pass filter 18 and amplified in RF amp 20. The output from the mixer 14 is filtered through a 320 MHz band pass filter 21, amplified in RF-amp 22, converted to a differential signal in a TXFm Balun 23 and then sampled in an 8-bit analog to digital (A/D) converter 24 at 1280 mega samples per second sampling. The A/D converter 24 also receives a clock signal from the 1280 MHz phase locked loop (PLL) 25. Both the 1280 MHz phase locked loop (PLL) 25 and the synthesizer 17 are referenced by a 10 MHz clock generated by the 10 MHz Reference Oscillator 15 going through the RF splitter 16.

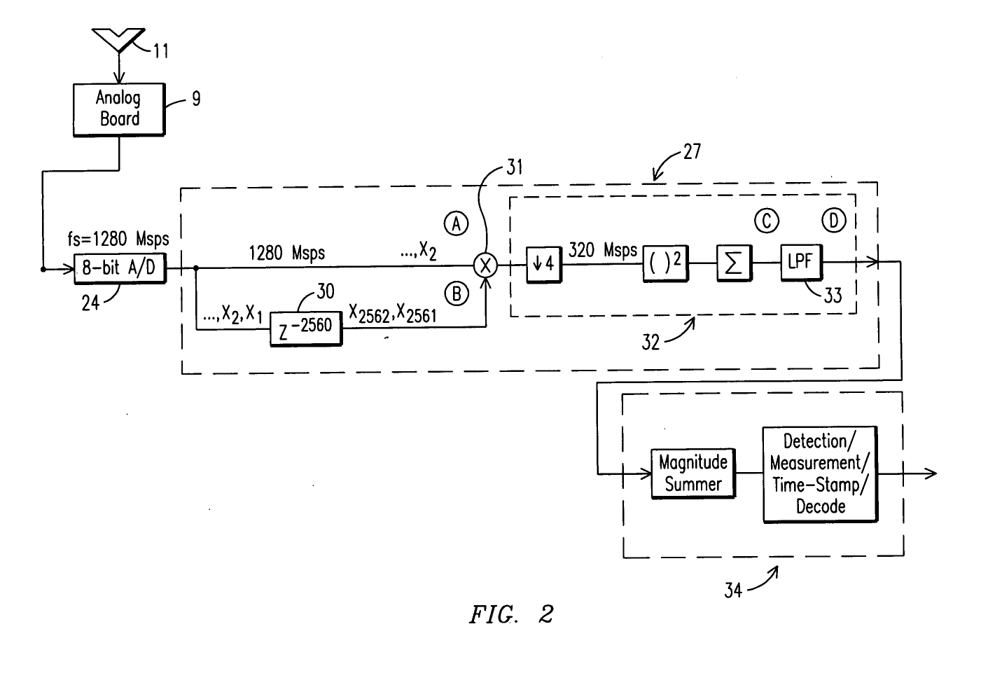

FIG. 2 is a digital signal flow path for the digital board 10.

The down converted IF signal is fed into the digital circuit 10, as seen in FIGS. 1 and 2 where it is sampled at 1280 Mega samples per second in the A/D converter 24 and fed to an Altera Stratix field programmable gate array (FPGA) 26 for digital signal processing. In the FPGA 26, the sampled IF signal is digitally processed. The time-domain delayed correlation is performed in the FPGA 26. The decoded signal is transmitted out the ethernet controller 28 to an output RJ 45 jack 29.

The signal stream through the digital board 10 can be followed in FIG. 2 in which a delayed version of the 1280 MSPS input stream is delayed by the 2560 MSPS clock 30 and is added to the original 1280 MSPS input stream. The pulse repetition interval (PRI) of 2000 ns at 1280 MSPS translates to 2560 clocks (sample rate×PRI=1280 MSPS×2000 ns/1000).

Thus the original waveform is delayed by 2560 clocks to create the second waveform, such that the second pulse of the original waveform aligns with the first pulse of the second waveform. The third pulse of the original waveform aligns with the second pulse of the second waveform, etc. The two wave streams are then multiplied in multiplier 31 and the output of the multiplier is fed to the rate converter/correlator 32 and down sampled and summed over a finite duration and fed into the low pass filter (LPF) 33 to smooth the waveform which is outputted to the digital signal processing (DSP) block 34 where it is detected, measured, time sampled and decoded.

It should be clear at this point that an ultra wide-band digital receiver's performance sensitivity has been improved by a digital time delayed correlation of the received signal. However the present invention is not to be construed as limited to the forms shown which are to be considered illustrative rather than restrictive.

We claim:

1. A method of improving an ultra wideband digital receiver's sensitivity comprising the steps of:
receiving a signal stream having multiple identical modulated pulses representing each data bit and having a constant time interval therebetween;
duplicating the signal stream having multiple identical modulated pulses for each data bit forming two signal streams of identical modulated pulses each having multiple identical modulated pulses for each data bit;
delaying said duplicate signal stream of said original signal stream by a predetermined time to align each first modulated pulse of said duplicate signal stream with the second modulated pulse of the original signal stream;
correlating each of said two signal streams of identical modulated pulses to form a single signal stream having one modulated pulse representing each data bit; and
detecting said single signal stream, thereby improving the sensitivity of a receiver.

2. The method of improving an ultra wideband receiver's sensitivity in accordance with claim 1 including the step of processing the received signal stream in an analog signal processing circuit prior to forming two digital signal streams therefrom.

3. The method of improving an ultra wideband receiver's sensitivity in accordance with claim 2 including the step of outputting the processed analog signal stream to a digital processing circuit.

4. The method of improving an ultra wideband receiver's sensitivity in accordance with claim 1 in which the step of delaying one said signal stream includes delaying one said duplicated signal stream by the constant time interval of the received signal stream to thereby align each modulated pulse of said duplicated signal stream data bit with each second modulated pulse of the original signal stream data bit.

5. The method of improving an ultra wideband receiver's sensitivity in accordance with claim 4 including the step of multiplying the original signal stream and the delayed duplicate signal stream.

6. A method of improving an ultra wideband digital receiver's sensitivity comprising the steps of:
receiving a signal stream having multiple identical modulated pulses representing each data bit, each of said signal stream received data bits having a constant time interval therebetween;
duplicating said received signal stream having multiple identical modulated pulses for each data bit into a plurality of signal streams of modulated pulses, each duplicated signal stream having multiple identical modulated pulses for each received data bit;
delaying said duplicate signal stream relative to said original signal stream to align the delayed duplicate signal stream pulses with the original signal stream pulses aligning offset pulses of identical signal streams;
correlating the aligned pulses to form a single signal stream having a stronger amplitude and having one modulated pulse representing each data bit; and
detecting said single correlated signal stream, thereby improving the sensitivity of a receiver.

7. The method of improving an ultra wideband receiver's sensitivity in accordance with claim 6 including the step of processing the received signal stream having a plurality of modulated pulses representing each data bit in an analog signal processing circuit.

8. The method of improving an ultra wideband receiver's sensitivity in accordance with claim 7 including the step of outputting the processed analog signal stream to a digital processing circuit.

9. The method of improving an ultra wideband receiver's sensitivity in accordance with claim 6 in which said original received signal stream and said duplicated signal stream each has two identical modulated pulses for each data bit and said duplicated signal stream is delayed to align the first pulse of said duplicate signal stream with the second pulse of original signal streams.

10. The method of improving an ultra wideband receiver's sensitivity in accordance with claim 6 in which the step of aligning the pulses includes delaying one duplicate signal stream to align the pulses thereof with the received signal stream for correlating offset identical modulated pulses in two data stream.

11. An ultra wideband digital receiver having improved sensitivity comprising:
means for receiving an ultra wideband digital signal stream having multiple identical pulses for each data bit and a constant time interval therebetween;
means for duplicating said received digital signal stream to form a plurality of signal streams each having multiple identical pulses for each data bit and a constant time interval therebetween;
means for aligning each of said plurality of signal streams with offset pulses therebetween;
means for correlating the aligned signal streams to form one signal stream from said plurality of signal streams; and
means for detecting the correlated signal stream;
thereby improving the sensitivity of an ultra wideband receiver.

12. An ultra wideband digital receiver having improved sensitivity in accordance with claim 11 in which the means for aligning the plurality of signal streams includes means for delaying one signal stream of said plurality of signal streams by a predetermined time to thereby align pulses of one of said plurality of signal streams with a delayed pulse of another of said plurality of signal streams whereby each signal pulse acts as a correlation template for another pulse.

13. An ultra wideband digital receiver having improved sensitivity in accordance with claim 11 in which the means for duplicating said received digital signal stream includes forming a duplicate of the received signal stream said duplicate signal stream and said received signal stream having identical pulses for each data bit of the received signal stream and having a constant time interval between each data bit.

14. An ultra wideband digital receiver having improved sensitivity in accordance with claim 13 in which the means for aligning the plurality of signal streams includes delaying a duplicated signal stream by the constant time interval of the received signal stream to thereby align the pulses of the duplicate signal stream with offset pulses of the received signal stream.

15. An ultra wideband digital receiver having improved sensitivity in accordance with claim 14 including a multiplier for multiplying said received signal stream with one said delayed duplicate signal stream.

16. An ultra wideband digital receiver having improved sensitivity in accordance with claim 15 in which said means for correlating the aligned signal streams includes a field programmable gate array.

17. An ultra wideband digital receiver having improved sensitivity comprising:
means for receiving an ultra wideband digital signal stream having multiple identical pulses for each data bit and a constant time interval therebetween;
means for duplicating said received digital signal stream to form a second identical signal stream to said received digital signal stream and having multiple identical pulses for each data bit and a constant time interval therebetween;
means for aligning the duplicated signal stream with the received signal stream by delaying the duplicated signal stream by the constant time interval of the received signal stream to thereby align delayed pulses of the duplicated signal stream with the pulses of a received signal stream whereby each pulse of the delayed duplicated signal stream acts as a correlation template for the received signal stream;
means for correlating the duplicate signal stream and the received signal stream to form one signal stream; and
means for detecting the correlated signal stream;
thereby improving the sensitivity of an ultra wideband receiver.
